(19) United States
(12) Patent Application Publication
(10) Pub. No.: US 2024/0248951 A1
(43) Pub. Date: Jul. 25, 2024

(54) CORRELATOR BANK FOR CORRELATED COEFFICENT SETS

(71) Applicant: Qorvo US, Inc., Greensboro, NC (US)

(72) Inventors: Andrew Fort, Kessel Lo (BE); Andrea Sabatini, Nijmegen (NL)

(21) Appl. No.: 18/397,039

(22) Filed: Dec. 27, 2023

Related U.S. Application Data
(60) Provisional application No. 63/439,999, filed on Jan. 19, 2023.

(51) Int. Cl. G06F 17/15

(52) U.S. Cl. CPC G06F 17/153

(57) ABSTRACT

In some embodiments, a circuit that performs a correlation between vectors of coefficients and a vector of input values (input vector) is disclosed. A multiplication block outputs a first vector of product values equal to a first one of a reference vector of coefficients multiplied by the input vector. A first calculation circuit sums the elements in a first vector of product values to generate a first output value. The correlation computation circuit also includes a second calculation circuit configured to: sum a difference vector of product values that correspond to each element in a difference vector of coefficients multiplied by each element in a difference vector of inputs to generate a summed output, multiply the summed output to generate a multiplied summed output, and output a second output value that is equal to the first output value minus or plus the multiplied difference value.

### RELATED APPLICATIONS

This application claims the benefit of provisional patent application Ser. No. 63/439,999, filed Jan. 19, 2023, the disclosure of which is hereby incorporated herein by reference in its entirety.

### FIELD OF THE DISCLOSURE

This disclosure relates to systems and methods that perform correlation operations.

### BACKGROUND

Correlation operations require that a vector of input values be multiplied by different vectors of correlation coefficients. The number of input values in the vector of input values can be high along with the number of correlation coefficients in each of the correlation coefficient vectors. Additionally, there may be large numbers of correlation coefficient vectors in the set. In conventional implementations, a bank of parallel correlators are used. Each correlator in the bank is responsible for a different one of the coefficient vectors. Each correlator multiplies and adds all the input values with all the correlation coefficients that correspond to the specific correlator. Given the large number of correlation coefficient vectors in the set, the correlation bank operations require large numbers of multipliers and large number of adders to perform all of the correlation operations. This makes the correlator banks costly and large. Furthermore, the large number of multipliers and adders consumes significant power which is undesirable in low-power coin-cell IoT (internet of things) devices.

### SUMMARY

In some embodiments, a correlation computation circuit that performs a correlation operation between a set of different coefficient vectors and a vector of input values (input vector), includes: a multiplication block configured to: output a first vector of product values that are equal to all the elements in a first one of the set of coefficient vectors (reference vector) multiplied by the input vector, wherein: a difference vector of coefficients are coefficients from the reference vector which are different than coefficients in a second one of the set of coefficients vectors (second vector); a difference vector of the inputs includes input values from the input vector that correspond to the coefficients which are different between the reference vector and second vector; and a first calculation circuit configured to sum the first vector of product values to generate a first output value. The correlation computation circuit also includes a second calculation circuit configured to: sum a difference vector of product values containing elements corresponding to the elements of the difference vector of coefficients multiplied by the elements of the difference vector of inputs to generate a summed output; multiply the summed output to generate a multiplied summed output; and output a second output value that is equal to the first output value minus the multiplied difference value.

In some embodiments, a correlation computation circuit that performs a correlation operation between different vectors of coefficients and a vector of input values (input vector), includes: an XOR block configured to: output a first vector of product values that contains elements which are equal to elements a first one of the set of coefficient vectors (reference vector) multiplied by the elements in the input vector, wherein: a difference vector of coefficients are coefficients from the reference vector which are different from coefficients in a second one of the set of coefficient vectors (second vector); and a difference vector of the inputs includes input values from the input vector that correspond to the coefficients which are different between the reference vector and second vector. Additionally, the correlation computation circuit includes a first calculation circuit configured to sum the first vector of product values to generate a first output value. The correlation computation circuit also includes: a second calculation circuit configured to: sum of the elements of a first vector of product values that contains elements corresponding to the elements of the difference set of coefficients multiplied by the elements of the difference vector of inputs to generate a summed output; multiply the summed output to generate a multiplied summed output; output a second output value that is equal to the first output value minus the multiplied difference value.

In some embodiments, a correlation computational method to perform a correlation operation between a set of different coefficient vectors and a vector of input values (input vector), includes: outputting a first vector of product values that contains elements which are equal to the elements of a first one of the set of coefficients vectors (reference vector) multiplied by the elements of the input vector, wherein a difference vector of coefficients are coefficients from the reference vector which are different than coefficients in a second one of the set of coefficient vectors (second vector) and a difference vector of inputs includes input values from the input vector that correspond to the coefficients which are different between the reference vector and second vector; summing the elements in the first vector product values to generate a first output value; summing the elements in a difference vector of product values that contains elements corresponding to the elements in a difference vector of coefficients multiplied by the difference vector of inputs to generate a summed output; multiplying the summed output to generate a multiplied summed output; and outputting a second output value that is equal to the first output value minus the multiplied difference value.

In some embodiments, a correlation computation circuit that performs a correlation operation between a set of different coefficient vectors and a vector of input values (input vector), including: a multiplication block configured to: output a first vector of product values that are equal to the elements in a first one of the set of coefficient vectors (reference vector) multiplied by the elements in the input vector, wherein: a difference vector of coefficients are elements from the reference vector which are different from corresponding elements in a second one of the set of coefficient vectors (second vector); a difference vector of the input includes the elements from the input vector that correspond to the elements which are different between the reference vector and the second vector; a first calculation circuit configured to sum all the elements in the first vector of product values to generate a first output value; a second calculation circuit configured to: sum only the elements in the first vector product values that correspond to the elements in the difference vector of coefficients multiplied by the elements in the difference vector of the input to generate a summed output; multiply the summed output to generate a multiplied summed output; output a second output value that is equal to the first output value minus the multiplied summed output.

In some embodiments, the correlation computation circuit further includes: a third calculation circuit configured to: invert a first intersection vector containing the elements from the difference vector of product values that are also in a second difference vector the second difference vector are elements from the second coefficient vector that are different from a third one of the set of coefficient vectors; receive a second intersection vector containing the elements from the second difference vector and a similarity vector, wherein the similarity vector are the elements that are the same between the second coefficient vector and the reference vector, sum the elements of the second intersection vector and an inversion of the elements in the first intersection vector to generate a second summed output; multiply the second summed output to generate a second multiplied summed output; and output a third output value that is equal to the second output value minus the second multiplied summed output.

In some embodiments, a correlation computation circuit that performs a correlation operation between a set of different coefficient vectors and a vector of input values (input vector), comprising: an XOR block configured to: output a first vector of product values that are equal to each element in a first one of the set of coefficient vectors (reference vector) x-ored by the corresponding element in the input vector, wherein: a difference vector of coefficients are elements from the reference vector which are different from corresponding elements in a second one of the set of coefficient vectors (second vector); a difference vector of inputs includes the elements from the input vector that correspond to the elements which are different between the reference vector and second vector; a first calculation circuit configured to sum all the elements in a first vector of product values to generate a first output value; a second calculation circuit configured to: sum the elements of a difference vector of product values that corresponds to the elements in a difference vector of coefficients multiplied by the elements in the difference vector of the input to generate a summed output; multiply the summed output to generate a multiplied summed output; output a second output value that is equal to the first output value minus a multiplied summed output.

In some embodiments, a correlation computational method to perform a correlation operation between different coefficient vectors from a set of coefficient vectors and an input vector (input vector), includes: outputting a first vector product values that are equal to the elements in a first one of the set of coefficient vectors (reference vector) multiplied by the elements in the input vector, wherein: a difference vector of coefficients are elements from the reference vector which are different from corresponding elements in a second one of the set of coefficient vectors (second vector); a difference vector of the input vector includes the elements from the input vector that correspond to the elements which are different between the reference vector and the second vector; summing the elements in the first vector of product values to generate a first output value; summing the elements in a difference vector of product values that correspond to the elements in a difference vector of coefficients multiplied by the elements in a difference vector of inputs to generate a summed output; multiplying the summed output to generate a multiplied summed output; and outputting a second output value that is equal to the first output value minus a multiplied summed output.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a correlation computation circuit, in accordance with some embodiments.

FIG. 2 is a correlation computation circuit, in accordance with some embodiments.

FIGS. 3A and 3B are correlation computation circuits that utilize X-OR type operations that are equivalent to multiplication, in accordance with some embodiments.

FIG. 4 is a flow diagram that describes a correlation computational method to perform a correlation operation between different sets of coefficients and a set of input values (input set).

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

This disclosure relates to systems and methods that perform correlation operations between an input vector and a set of correlation vectors. The correlation computation circuits described herein reuse already multiplied product values for the different set of coefficient vectors to greatly reduce the number of multipliers and adders involved to obtain each correlation value. More specifically, product values are calculated for each element of a reference coefficient vector multiplied by corresponding elements of the vector of input values to obtain a reference vector of product values. Elements of the reference vector of product values are added together to obtain a reference output value. However, to obtain the other output values for the other coefficient vectors, difference vectors of product values are obtained. The difference vector of product values includes only product values for coefficients that are different between the reference vector of coefficients and another one of the coefficient vectors. The other output values from the other coefficient vectors are determined by adding the elements of the difference vector together with either the reference value or the reference value of a previous output value calculation based on known relationships between the set of coefficient vectors, as explained below. In this manner, the product values of a single coefficient vector are reused for all of the coefficient vectors greatly reducing the number of multiplications and additions used to calculate all of the output values. This greatly reduces the cost, size, and energy consumption of the disclosed correlation computation circuits.

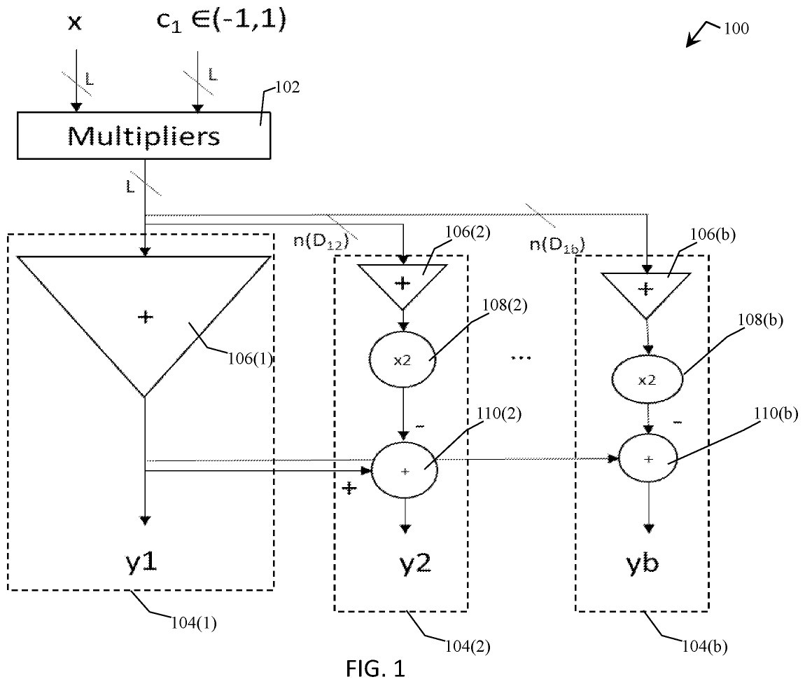

FIG. 1 is a correlation computation circuit 100, in accordance with some embodiments.

The correlation computation circuit 100 is configured to perform a correlation between a vector of input values (input vector) and a set of coefficient vectors. For the purposes of discussion, the input vector is represented by the letter x. When an index is associated with the letter x, the element x and the index represent a particular input value of the input vector. The input vector has L elements where L represents an integer greater or equal to 2. In a typical embodiment, the letter L represents an integer of at least many hundreds (e.g., L=256). Each of the coefficient vectors is represented by the letter c and an index. The index represents an integer from 1 to b, where b is an integer greater or equal to 2. Thus, for example, the vector c₁ represents a coefficient vector. The vector c₂ represents another coefficient vector from the set of coefficient vectors. A particular element in a coefficient vector is represented with a double index, where the first identifies the vector described above and the second index represents a particular coefficient in the vector. For example, the element c_{1,2} represents the second coefficient in the coefficient vector c₁. The number of coefficients in each coefficient vector and the number of input values in the input vector are equal to one another. Each output correlation value is represented by the letter y and an index indicating the particular correlation value. The index represents an integer from 1 to b.

The output correlation value can be calculated in accordance with equation 1:

yᵢ=Σₗ₌₁^{L}xₗCᵢₗ, where i is an integer from 1 to b.

Thus, there are two parts to the calculation of the output correlation value yᵢ, the first being the calculation of the product values xₗCᵢₗ and then the calculation of the summation of the product values xₗcᵢₗ. However, the correlation computation circuit 100 does not actually calculate the product values xᵢcᵢₗ for each coefficient vector cᵢ in the set of coefficients vectors. Instead, the correlation computation circuit 100 only calculates the product values xₗcᵢₗ and sums the product values xₗcᵢₗ for a reference coefficient vector. In this example, the index of the reference vector is i=1. However, it should be noted that the reference coefficient vector may be any other one of the coefficient vectors. Once the reference output correlation value, y₁ is calculated from the reference coefficient vector, every other correlation value in the set of correlation values is calculated in accordance with the equivalency in equation 2:

yₜ=y₁−2Σ_{mϵD}_{₁ₜ}xₘc₁ₘ, where t is a value between 2 and the integer b.

The equivalency in equation 2 assumes that each of the coefficients of every coefficient vector can be one of two values either +1 or −1. This presumption is valid in many IoT communication systems. IoT communication systems typically use constant envelope modulations for the most power-efficient PA design. Since the amplitude does not contain any information, these signals can be very closely approximated with hard-limiting 1-bit signals without losing significant performance making the methodology described herein particularly well-suited for IoT systems. The set D₁ₜ is a difference set of indices. D₁ₜ represents the indices to elements in coefficient vector cₜ that are different from the same elements of the reference vector c₁. To provide a simplified example (for the purposes of explanation only), if coefficient vector c₁ equals [1, −1, 1] and coefficient vector c₂ equals [1, 1, 1] then a difference set of indices D₁ₜ would include the index {2} since c_{1,2} is equal to −1 but c_{2,2} is equal to 1. The difference vector of product values includes each of the product values xₘc₁ₘ for each of the coefficients that are different between the reference coefficient vector c₁ and the coefficient vector cₜ. Thus, the only product value calculated to determine y₂ would be 1*x₂ and y2=y₁−2(x₂*−1). Thus, the equivalency in equation 2 is significantly less computationally intensive because the product values from the reference set are simply reused. This savings becomes substantial for large vector lengths L, and if c1 and ct are well correlated. This is commonly the case in IoT systems.

Referring now to the components of the correlation computation circuit 100 shown in FIG. 1, the correlation computation circuit 100 includes a multiplication block 102. The multiplication block 102 is configured to output a first vector of product values that are equal to the coefficient reference vector multiplied by the input vector. More specifically, each product value in the first element in the vector of product values is equal to xₗc₁ₗ, where I is an index between 1 and L. Thus, a first product value in the reference vector of product values is equal to x₁c_{1,1}, the second product value in the reference set of product values is equal to x₁, c_{1,2}, the third product value in the reference set of product values is equal to x₁, c_{1,3}, etc. In FIG. 1, the multiplication block 102 includes a network of multipliers that are configured to multiply xₗc₁ₗ to determine the first vector of product values. In other embodiments, the multiplication block 102 may include other components that do not actually perform multiplication but that output a first vector of product values that represents the reference coefficient vector x-ored with the input vector.

In some embodiments, the multiplication block 102 (and other multiplication blocks discussed in this disclosure) perform multiplication operations to obtain their desired results. However, the multiplication block may not perform multiplication operations but rather other operations having results that are equal to a multiplication operation. For example, in some embodiments, the multiplication block 102 performs “X-OR” type operations. Exemplary “X-OR” type operations include X-OR operation, EXOR operations, or NEXOR operations. When the vectors are binary values, these operations have results that are equivalent to multiplication operations. For example, X-OR operations are equivalent to multiplication operations when a 0 is represented +1 and 1 is represented by −1. In these binary type situations, the X-OR type operations are equivalent to multiplication operations.

The reference vector of product values are then provided to a calculation circuit 104(1). The calculation circuit 104(1) is configured to sum the elements in the reference vector of product values to output the reference output value y₁. In this embodiment, the calculation circuit 104(1) includes an adder pyramid 106(1) that is configured to add all of the product values in the reference vector of product values and thereby output the reference output value y₁.

The product values in the reference vector of product values are then reused to calculate the other output values yₜ corresponding to the correlation of the input vector x with other coefficient vectors cₜ. More specifically, the correlation computation circuit 100 includes a calculation circuit 104(2)-104(b) (referred to generically as 104(t)). Each of the calculation circuits is configured to receive the difference vector of product values that includes each of the product values xₘc₁ₘ, where mϵD₁ₜ (i.e, the difference vector of product values consists of all of the corresponding product values from the reference vector of product values where c₁ₘ is different from cₜₘ). Each of the calculation circuits 104(t) is further configured to receive the reference output value y₁. The calculation circuit then calculates the correlation output value yₜ as y₁−2Σ_{mϵD}_{₁ₜ}xₘc₁ₘ. Each of the calculation circuits 104(t) includes an adder pyramid 106(2)-106(b) (referred to generically as 106(t)). The adder pyramid 106(t) is configured to calculate the summation Σ_{mϵD}_{₁ₜ}xₘc₁ₘ. Note that each of the adder pyramids 106(t) are smaller than the adder pyramid 106(1) since the adder pyramids 106(t) only need to add the product values from a difference vector of product values which has less than L elements. The adder pyramids 106(t) are configured to output the summation Σ_{mϵD}_{₁ₜ}xₘc₁ₘ to a doubling circuit 108(2)-108(b) (referred to generically as 108(t)). In some embodiments, the doubling circuit 108(t) is provided as a multiplier that multiplies the summation by 2. In some embodiments, the doubling circuit 108(t) is an adding circuit that adds the summation to itself. In other embodiments, the doubling circuit is a shift-left operation on a register of binary values.

The calculation circuit 104(t) is further configured to receive the reference output value y₁ at a subtraction circuit 110(2)-110(b) (referred to generically as subtraction circuit 110(t)). The subtraction circuit 110(t) is configured to subtract the output from the doubling circuit 108(t) from the reference output value y₁. In this manner, the correlation output value yₜ is calculated for each coefficient vector cₜ in accordance with equation 2.

For wireless IoT applications, we can expect the number of elements in D_{1b}, denoted by n(D_{1b}), to be much less than L resulting in significantly lower power consumption, coefficient storage, and area. First, since we limit the coefficients c to hard-limited values {−1,1}, then even for uncorrelated coefficient vectors, on average, half the coefficients are different resulting in about 50% less computation. However, in most IoT applications we can expect correlator coefficients to be well-correlated where nearly all the bits are the same. For example, in Zigbee and BLE synchronizations, we typically correlate the input signal, x, against several versions of the same preamble signal shifted slightly in frequency so that most of the bits are the same between coefficient vectors. As another example, in BLE GFSK data detection we are typically correlating the input signal, x, against several possible transmitted symbol sequences. Sequences that only differ by 1 or 2 symbols will have most of their bits in common. Finally, we can engineer valid coefficient sets to have as many bits in common as possible to maximize power savings.

In some embodiments, the values of the coefficients in each coefficient vector c are fixed. This means that the routing for the summations to the adder pyramid 106(t) are hard wired since the routing will be done already knowing the difference sets. If the values of the coefficients in each coefficient vector are not known then routing to the summations to the adder pyramid 106(t) will be done through some selection circuitry, such as a multiplexer.

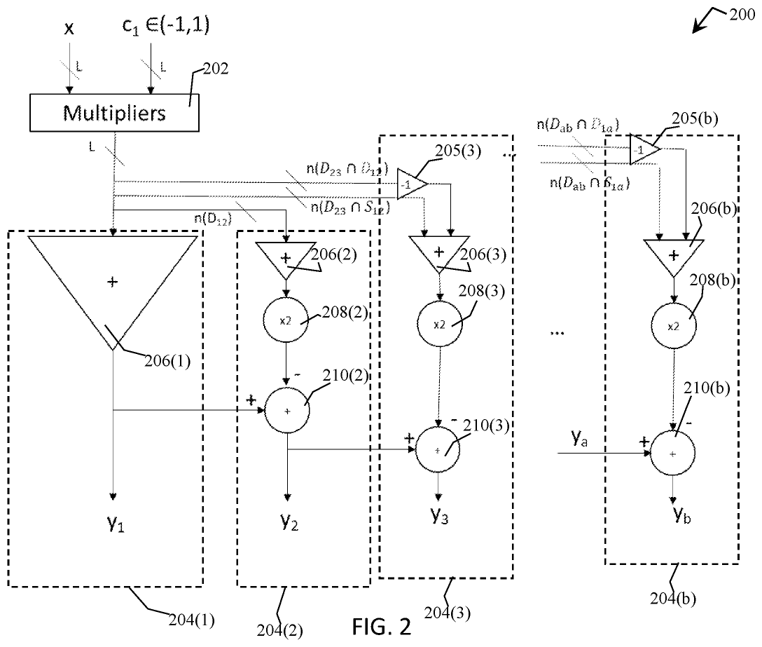

FIG. 2 is a correlation computation circuit 200, in accordance with some embodiments.

The correlation computation circuit 200 is configured to perform a correlation calculation between the input vector x and different vectors of coefficients cₜ. Coefficient elements in each of the coefficient vectors are again assumed to have a value of either +1 or −1. The correlation computation circuit 200 includes a multiplication block 202, which in this embodiment is the same as the multiplication block 102 discussed above with respect to FIG. 1. The correlation computation circuit 200 includes calculation circuits 204(1)-204(b). The calculation circuit 204(1) is the same as the calculation circuit 104(1) and calculates the output value y₁ in the same manner described above with respect to FIG. 1. The calculation circuit 204(2) is the same as the calculation circuit 104(2) and calculates the output value y₂ in the same manner described above with respect to FIG. 1.

The calculation circuits 204(3)-204(b) (referred to generically as calculation circuits 204(v)) receive a group of product values from the multiplication block 202. In FIG. 2, the calculation circuits 204(v) calculate the reference values yᵥ in accordance with equation 3:

$${y}_{v} = {y}_{v - 1} - 2 [ {\sum }_{m ∈ {D}_{v - 1 , v} ∩ {S}_{1 , v - 1}} {x}_{m} {c}_{1 m} + {\sum }_{m ∈ {D}_{v - 1 , v} ∩ {D}_{1 , v - 1}} - {x}_{m} {c}_{1 m} ]$$

It can be shown that equation 2 and equation 3 are equivalent. In this embodiment, the set S represents the indices to elements between two coefficient vectors c that are the same. Thus, the set S_{1,2} refers to the indices of coefficients in the vector c₁ that are the same as corresponding coefficients in vector c₂. D_{v-1,v}∩S_{1,v-1} represents the intersection between D_{v-1,v} and S_{1,v-1}. The difference set of indices D_{v-1,v} refers to the indices of the coefficients in the coefficient vector cᵥ that are different from corresponding coefficients in cᵥ₋₁, where v−1 indicates the previous stage. The similarity set S_{1,v-1} refers to the indices for the coefficients in the reference coefficient vector c₁ that are the same as corresponding coefficients in coefficient vector cᵥ₋₁. D_{v-1,v}∩D_{1,v-1} is the intersection between the difference set D_{v-1,v} and the difference set D_{1,v-1}. The difference set D_{1,v-1} are indices for coefficients in the reference vector c₁ that are different from corresponding coefficients in the coefficient vector cᵥ₋₁.

Each of the calculation circuits 204(v), has a set of inverters 205(3)-205(b) (referred to generically as set of inverters 205(v)). The set of inverters 205(3)-205(b) inverts the vector of product values Each of the calculation circuits 204(v) includes an adder pyramid 206(2)-206(b) (referred to generically as 206(v)). The adder pyramid 206(v) is configured to calculate the summation Σ_{mϵD}_{_{v-1,v}}_{∩s}_{_{1,v-1}}xₘc₁ₘ+Σ_{mϵD}_{ᵥ}_{∩D}_{_{1,v-1}}−xₘc₁ₘ. Note that each of the adder pyramids 206(v) are smaller than the adder pyramid 106(1) since the adder pyramids 106(v) only need to add the product values from a difference vector of product values which has less than L elements. The adder pyramids 206(v) are configured to output the summation Σ_{mϵD}_{_{v-1,v}}_{∩s}_{_{1,v-1}}xₘc₁ₘ+Σ_{mϵD}_{ᵥ}_{∩D}_{_{1,v-1}}−xₘc₁ₘ to a doubling circuit 208(3)-208(b) (referred to generically as 208(v)). In some embodiments, the doubling circuit 208(v) is provided as a multiplier that multiplies the summation Σ_{mϵD}_{_{v-1,v}}_{∩s}_{_{1,v-1}}xₘc₁ₘ+Σ_{mϵD}_{ᵥ}_{∩D}_{_{1,v-1}}−xₘc₁ₘ by 2. In some embodiments, the doubling circuit 208(v) is an adding circuit that adds the summation Σ_{mϵD}_{_{v-1,v}}_{∩s}_{_{1,v-1}}xₘc₁ₘ+Σ_{mϵD}_{ᵥ}_{∩D}_{_{1,v-1}}−xₘc₁ₘ to itself.

The calculation circuit 204(v) is further configured to receive the correlation output value yᵥ₋₁ (i.e., the correlation output value of the previous and adjacent stage). A subtraction circuit 210(3)-210(b) (referred to generically as subtraction circuit 210(v)). The subtraction circuit 210(v) is configured to subtract the output from the doubling circuit 208(v) from the reference output value yᵥ₋₁. In this manner, the correlation output value yᵥ is calculated for each coefficient vector cᵥ in accordance with equation 3.

This correlation computation circuit 200 is particularly useful for synchronization in Zigbee/Matter systems where we typically correlate the input vector, x, against the same preamble shifted slightly in frequency. For example, during synchronization, c₁ represents the preamble with no frequency offset, c₂ is the same preamble with 30 kHz offset, and (in general) c_{b} is the same preamble with (b−1)30 kHz. In some embodiments, adjacent coefficient vectors, such as c₂ and c₃ or c₅ and c₆, have more bits in common with each other than with c₁.

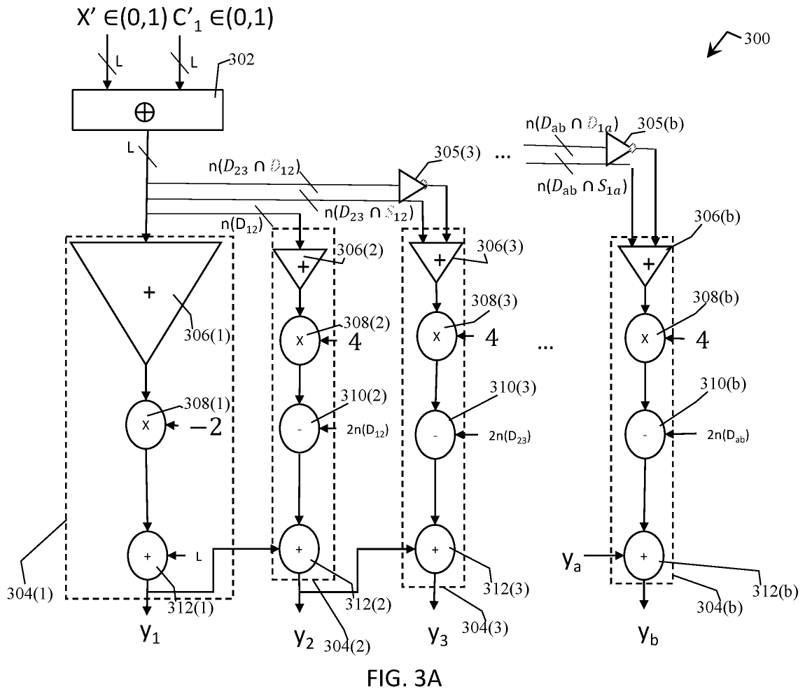

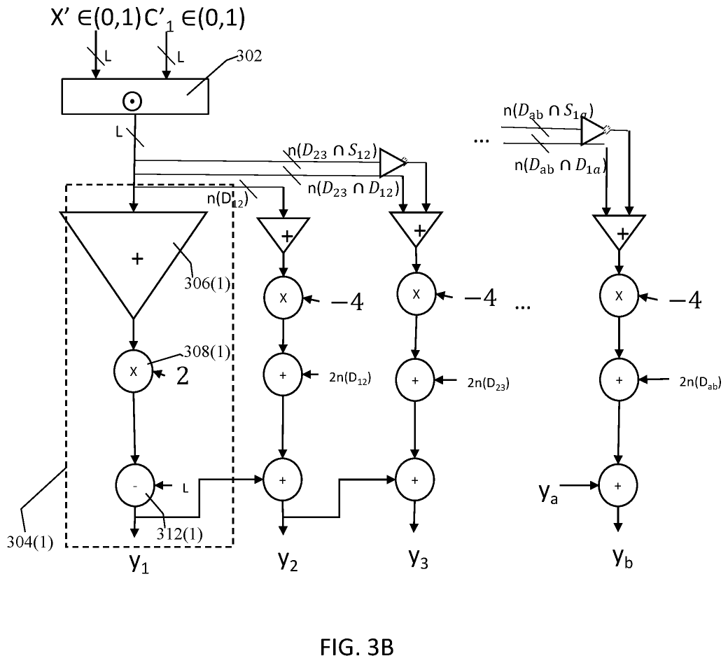

FIG. 3A is a correlation computation circuit 300, in accordance with some embodiments.

The correlation computation circuit 300 is for EXOR operations. The correlation computation circuit 300 is configured to perform a correlation calculation between the input vector x′ and different set of coefficient vectors cₜ′. The input values in the input vector x′ are assumed to have a value of either +1 or 0. Coefficients in each of the coefficient vectors cₜ′ are again assumed to have a value of either +1 or 0. The correlation computation circuit 300 includes a multiplication block 302. In this embodiment, the multiplication block 302 is an XOR block. The XOR block includes a network of XOR gates, which perform XOR logic operations. The correlation computation circuit 300 includes calculation circuits 304(1)-304(b).

The correlation computation circuit 100 only calculates the product values xₗcᵢₗ and sums the product values xₗcᵢₗ for a reference coefficient vector which in this example the index of the reference vector is i=1. However, it should be noted that the reference coefficient vector may be any other one of the coefficient vectors.

The calculation circuit 304(1) includes an adder pyramid 306(1) that adds the reference vector of product values. The output of the adder pyramid 306(1) is provided to a multiplication block 308(1) that multiplies the summation of the reference vector of product values by −2 to output a multiplied summed output. An adder 312(1) then adds the value of L to calculate the correlation output value y₁. This corrects for the fact that the XOR block does not represent a true multiplication operation.

The calculation circuit 304(2) is configured to calculate:

$${y}_{2} = {y}_{1} + 4 {\sum }_{m ∈ {D}_{1 , 2}} {x}_{m}^{′} {c}_{1 m}^{′} - 2 n ( {D}_{1 , 2} )$$

The calculation circuit 304(2) includes an adder pyramid 306(2) that is configured to receive the product values for the difference set of indices D_{1,2}. The adder pyramid 306(2) is configured to add the product values to calculate Σ_{mϵD}_{_{1,2}}x′ₘc′₁ₘ. A quadrupling circuit 308(2) is configured to quadruple the output of the adder pyramid 306(2) to calculate 4Σ_{mϵD}_{_{1,2}}x′ₘc′₁ₘ. The subtraction circuit 310(2) receives the output of the adder pyramid 306(2) and the value of 2n(D_{1,2}) where n(D_{1,2}) is the number of elements in the difference set of indices D_{1,2}. A adder circuit 312(2) is configured to receive the correlation output value y₁ and the output of the subtraction circuit 310(2) to calculate the output equal to y2=y₁+4Σ_{mϵD}_{_{1,2}}x′ₘc′₁ₘ−2n2(D_{1,2}).

The calculation circuits 304(3)-304(b) (referred to generically as calculation circuits 304(v)) receive a group of coefficients from the multiplication block 302. In FIG. 2, the calculation circuits 304(v) calculate the reference values yᵥ in accordance with equation 4:

$${y}_{v} = {y}_{v - 1} + 4 [ \text{} {\sum }_{m ∈ {D}_{v - 1 , v} ∩ {S}_{1 , v - 1}} {x}_{m}^{′} ⊕ {c}_{1 m}^{′} + {\sum }_{m ∈ {D}_{v - 1 , v} ∩ {D}_{1 , v - 1}} {x}_{m}^{′} ⊙ {c}_{1 m}^{′} ] - 2 n ( {D}_{v - 1 , v} )$$

It can be shown that equation 3 and equation 4 are equivalent. Where ⊙ represents a bitwise “nexor” operation and ⊕ represents a bit-wise “xor” operation. In interpreting the above equations, it is helpful to think of the “nexor” operator together with the adder pyramid as counting the number of bits in x′ and c₁′ that are the same. Likewise, the “xor” operation together with the adder pyramid counts the number of bits in x′ and c₁′ that are different.

Each of the calculation circuits 304(v), has a set of inverters 305(1)-305(b) (referred to generically as set of inverters 305(v). The set of inverters 305(1)-305(b) inverts the vector of product values Each of the calculation circuits 304(v) includes an adder pyramid 306(2)-306(b) (referred to generically as 206(v)). The adder pyramid 306(v) is configured to calculate the summation [Σ_{mϵD}_{_{v-1,v}}_{∩s}_{_{1,v-1}}x′ₘ⊕c′₁ₘ+Σ_{mϵD}_{_{v-1,v}}_{∩D}_{_{1,v-1}}x′ₘ⊙c′₁ₘ]. Note that each of the adder pyramids 306(v) are smaller than the adder pyramid 106(1) since the adder pyramids 106(v) only need to add the product values from a difference vector of product values which has less than or equal to L elements. The adder pyramids 306(v) are configured to output the summation [Σ_{mϵD}_{_{v-1,v}}_{∩s}_{_{1,v-1}}x′ₘ⊕c′₁ₘ+Σ_{mϵD}_{_{v-1,v}}_{∩D}_{_{1,v-1}}x′ₘ⊙c′₁ₘ] to a quadrupling circuit 308(2)-308(b) (referred to generically as 308(v)). In some embodiments, the quadrupling circuit 308(v) is provided as a multiplier, a set of adders, a “left shift” operation that multiplies the summation [Σ_{mϵD}_{_{v-1,v}}_{∩s}_{_{1,v-1}}x′ₘ⊕c′₁ₘ+Σ_{mϵD}_{_{v-1,v}}_{∩D}_{_{1,v-1}}x′ₘ⊙c′₁ₘ] by 4. In some embodiments, the quadrupling circuit 308(v) is an adding circuit that adds the summation [Σ_{mϵD}_{_{v-1,v}}_{∩s}_{_{1,v-1}}x′ₘ⊕c′₁ₘ+Σ_{mϵD}_{_{v-1,v}}_{∩D}_{_{1,v-1}}x′ₘ⊙c′₁ₘ] to itself 3 times.

A subtraction circuit 310(3)-310(b) (referred to generically as subtraction circuit 310(v)) is provided. The subtraction circuit 310(v) is configured to subtract 2n(D_{v-1,v}) from the output of the quadrupling circuit 308(v) An adder circuit 312(3)-312(b) (referred to generically as adder circuit 312(v)) is configured to receive reference output value yᵥ−1 and add the output of the subtraction circuit 310(v) where the output of the adder circuit is equal to the correlation output value yᵥ. The correlation computation circuit 300 thus operates on binary bit values 1 and 0.

When possible, coefficients should be chosen so that Cᵥ₋₁ and cᵥ from equations 1˜4 have as many elements in common as possible or, equivalently, to minimize n(D_{v-1,v}). This minimizes the computational cost of the various correlation computation circuits 100-300. In a lot of cases, several possible coefficient sets will result in roughly the same behavior. An important special case of this is non-coherent synchronization and detection, common in low-cost IoT devices, where the phase of the coefficient sets can be chosen arbitrarily with no significant impact on performance. In some embodiments, the phase of each correlation set is selected so the first coefficient corresponds at the same phase. For synchronization purposes, correlation coefficients represent the same sequence at different frequency offsets so that bits between correlation coefficients are the same at the start of the sequence but deviate substantially at the end of the sequence. In some embodiments, a better choice of coefficients is to phase align each coefficient set to the middle of the sequence to minimize the number of bits that are different between coefficient sets representing different frequency offsets. For other applications, an optimal set of coefficients which minimizes total computational power of the correlation computation circuits 100-300 can be determined by a brute force search of correlation sets at different phase offsets.

FIG. 3B is a correlation computation circuit 350, in accordance with some embodiments.

The correlation computation circuit 350 is for NEXOR operations. The correlation computation circuit 350 is the same as the correlation computation circuit 300 except that the multiplication block 308(1) multiplies the summation of the reference vector of product values by 2, the inverter 305(v) inverts D_{v-1,v}∩S_{1,v-1} while D_{v-1,v}∩D_{1,v-1} is received directly by the adder pyramid 306(v), the quadrupling circuit 308(2) and quadrupling circuit 308(v) quadruple and invert, the circuits 310(2), 310(v) are adder circuits instead of subtraction circuits, the circuit 312(1) is a subtraction circuit instead of an adder circuit.

It should be noted that the correlation computation circuits 100, 200, 300, and 350 in FIGS. 1-3B may be formed on one or more integrated circuit (IC) chips.

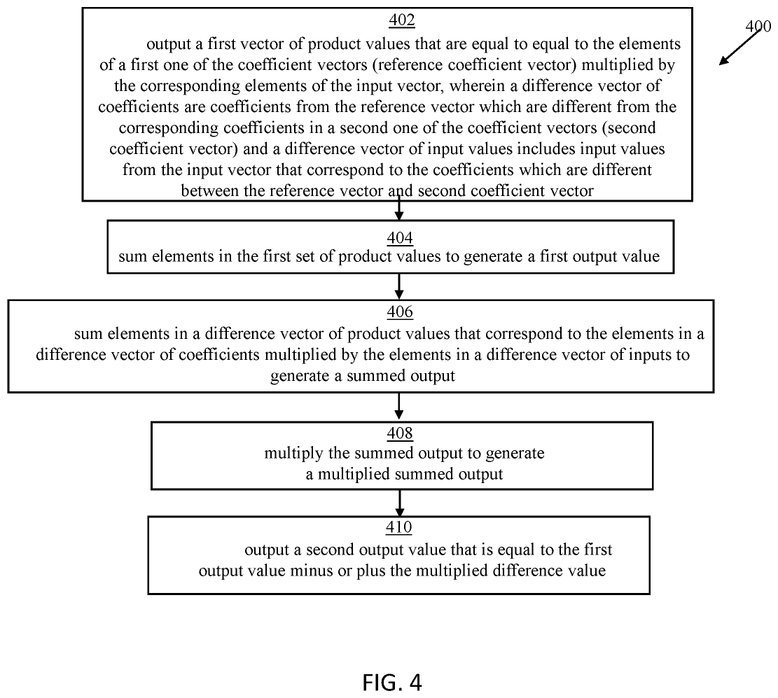

FIG. 4 is a flow diagram 400 that describes a correlation computational method to perform a correlation operation between different sets of coefficients and a set of input values (input set).

The correlation computation circuits 100-300 are examples of devices that perform the flow diagram 400. The flow diagram 400 includes block 402-410. Flow begins at block 402.

At block 402, a first vector of product values is output. Elements in the first vector of product values are equal to the elements of a first one of the coefficient vectors (reference coefficient vector) multiplied by the corresponding elements of the input vector, wherein a difference vector of coefficients are coefficients from the reference vector which are different from the corresponding coefficients in a second one of the coefficient vectors (second coefficient vector) and a difference vector of input values includes input values from the input vector that correspond to the coefficients which are different between the reference vector and second coefficient vector.

An example of the first vector of product values is the output from the multiplication block 102 in FIG. 1, the output from the multiplication block 202 in FIG. 2, and the output from the multiplication block 302 in FIG. 3. An example of offset of coefficient vectors are the coefficients c discussed in FIGS. 1-2 and the coefficients c′ discussed in FIG. 3. An example of the reference vector of coefficients is the vector of coefficients c₁ discussed in FIGS. 1-2, and the vector of coefficients c₁′ discussed in FIG. 3. An example of the input vector is the input vector x in FIGS. 1-2 and the input vector x′ in FIG. 3. An example of the difference vector of coefficients are the elements from c₁ and c₂ that are different from one another with respect to FIG. 1 and FIG. 2. An example of the difference vector of coefficients are the coefficients from c₁′ and c₂′ that are different from one another with respect to FIG. 1 and FIG. 2. An example of the difference vector of inputs is the input values from the input vector that corresponds to the coefficients from c₁ and c₂ that are different from one another with respect to FIG. 1 and FIG. 2. An example of the difference vector of inputs is the input values from the input vector that corresponds to the coefficients from c₁′ and c₂′ that are different from one another with respect to FIG. 3. Flow then proceeds to block 404.

At block 404, elements in the first vector of product values are summed to generate a first output value. An example of the first output value is the output from the adder pyramid 106(1) in FIG. 1, the output from the adder pyramid 206(1) in FIG. 2, and the output from the adder 312(1) in FIG. 3. Flow then proceeds to block 406.

At block 406, elements in a difference vector of product values are summed. The elements in the difference vector of product values correspond to elements in a difference vector of coefficients multiplied by the elements in a difference vector of inputs to generate a summed output. An example of the difference vector of product values correspond to the line of width n(D_{1,2}) in FIG. 1-3. An example of the summed output is the output from the adder pyramid 106(2) in FIG. 2, the output from the adder pyramid 206(2) in FIG. 2, and the output from the adder pyramid 306(2) (2) in FIG. 3. Flow then proceeds to block 408.

At block 408, the summed output is multiplied to generate a multiplied summed output. An example of the multiplied summed output is the output of the doubling circuit 108(2) in FIG. 1, the output of the doubling circuit 208(2) in FIG. 2, and the output of the quadrupling circuit 308(2) in FIG. 3. Flow then proceeds to block 410.

At block 410, a second output value is generated that is equal to the first output value minus or plus the multiplied difference value. An example of the second output value is the output of the subtraction circuit 110(2) in FIG. 1, the output of the subtraction circuit 210(2) in FIG. 2, and the output of the adder circuit 312(2) in FIG. 3.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A correlation computation circuit that performs a correlation operation between a set of different coefficient vectors and a vector of input values (input vector), comprising:
a multiplication block configured to:
output a first vector of product values that are equal to elements in a first one of the set of coefficient vectors (reference vector) multiplied by corresponding elements in the input vector, wherein:
a difference vector of coefficients are the elements in the reference vector which are different from corresponding elements in a second one of the set of coefficient vectors (second vector);
a difference vector of the input vector includes the elements in the input vector that correspond to the elements which are different between the reference vector and the second vector;
a first calculation circuit configured to sum all elements in the first vector of product values to generate a first output value; and
a second calculation circuit configured to:
sum only elements in the first vector of product values that correspond to elements in the difference vector of coefficients multiplied by elements in the difference vector of the input vactor to generate a summed output;
multiply the summed output to generate a multiplied summed output; and
output a second output value that is equal to the first output value minus or plus the multiplied summed output.

2. The correlation computation circuit of claim 1, further comprising:
a third calculation circuit configured to:
invert a first intersection vector containing elements from a difference vector of product values that are also in a second difference vector the second difference vector are elements from the second coefficient vector that are different from a third one of the set of coefficient vectors;
receive a second intersection vector containing elements from the second difference vector and a similarity vector, wherein the similarity vector are the elements that are the same between the second coefficient vector and the reference vector;
sum elements of the second intersection vector and an inversion of elements in the first intersection vector to generate a second summed output;
multiply the second summed output to generate a second multiplied summed output; and
output a third output value that is equal to the second output value minus or plus the second multiplied summed output.

3. The correlation computation circuit of claim 1, wherein each of the elements in each set of the coefficient vectors is selected as one of two values, the two values being +1 or −1.

4. The correlation computation circuit of claim 1, wherein each of the elements in each set of the coefficient vectors represent a constant envelope modulation of a hard-limiting 1-bit signal.

5. The correlation computation circuit of claim 1, wherein the multiplication block performs X-OR type operations.

6. The correlation computation circuit of claim 5, wherein the X-OR type operations include one or more of X-OR operations, EXOR operations, or NEXOR operations.

7. The correlation computation circuit of claim 1, wherein the second calculation circuit is configured to multiply the summed output by 2 to generate the multiplied summed output.

8. The correlation computation circuit of claim 1, wherein the correlation computation circuit is formed on one or more integrated circuit, IC, chips.

9. A correlation computation circuit that performs a correlation operation between a set of different coefficient vectors and a vector of input values (input vector), comprising:
an XOR block configured to:
output a first vector of product values that are equal to each element in a first one of the set of coefficient vectors (reference vector) x-ored by a corresponding element in the input vector, wherein:
a difference vector of coefficients are elements from the reference vector which are different from corresponding elements in a second one of the set of coefficient vectors (second vector);
a difference vector of inputs includes the elements from the input vector that correspond to the elements which are different between the reference vector and second vector;
a first calculation circuit configured to sum all the elements in a first vector of product values to generate a first output value;
a second calculation circuit configured to:
sum the elements of a difference vector of product values that corresponds to the elements in a difference vector of coefficients multiplied by the elements in the difference vector of the input to generate a summed output;
multiply the summed output to generate a multiplied summed output;
output a second output value that is equal to the first output value minus or plus a multiplied summed output.

10. The correlation computation circuit of claim 9, wherein each of the elements in each set of the coefficient vectors is selected as one of two values, the two values being +1 or −1.

11. The correlation computation circuit of claim 9, wherein each of the elements in each set of the coefficient vectors represent a constant envelope modulation of a hard-limiting 1-bit signal.

12. The correlation computation circuit of claim 9, wherein the X-OR block performs X-OR type operations.

13. The correlation computation circuit of claim 12, wherein the X-OR type operation includes one or more of X-OR operation, EXOR operations, or NEXOR operations.

14. The correlation computation circuit of claim 9, wherein the second calculation circuit is configured to multiply the summed output by 2 to generate the multiplied summed output.

15. The correlation computation circuit of claim 9, wherein is formed on one or more integrated circuit (IC) chips.

16. A correlation computational method to perform a correlation operation between different coefficient vectors from a set of coefficient vectors and an input vector (input vector), comprising:
outputting a first vector of product values that are equal to equal to the elements of a first one of the coefficient vectors (reference coefficient vector) multiplied by the corresponding elements of the input vector, wherein a difference vector of coefficients are coefficients from the reference vector which are different from the corresponding coefficients in a second one of the coefficient vectors (second coefficient vector) and a difference vector of input values includes input values from the input vector that correspond to the coefficients which are different between the reference vector and second coefficient vector;
summing the elements in the first vector of product values to generate a first output value;
summing the elements in a difference vector of product values that correspond to the elements in a difference vector of coefficients multiplied by the elements in a difference vector of inputs to generate a summed output;
multiplying the summed output to generate a multiplied summed output; and
outputting a second output value that is equal to the first output value minus a multiplied summed output.

17. The correlation computation method of claim 16, wherein each of the elements in each set of the coefficient vectors is selected as one of two values, the two values being +1 or −1.

18. The correlation computation method of claim 16, wherein each of the elements in each set of the coefficient vectors represent a constant envelope modulation of a hard-limiting 1-bit signal.

19. The correlation computation method of claim 16, wherein multiplying the summed output comprises multiplying the summed output by 2.

20. The correlation computation circuit of claim 16, further comprising multiplying the elements in the difference vector of coefficients by the elements in the difference vector of inputs.
